(19) United States
(12) Patent Application Publication
(10) Pub. No.: US 2026/0361230 A1
(43) Pub. Date: Nov. 12, 2026

(54) Bidirectional Electric Converter Device with Dual Active Bridge Converter in Series with DC/AC Bridge Converter

(71) Applicant: embeX GmbH, Freiburg (DE)

(72) Inventor: Tobias THEOPOLD, Dortmund (DE)

(73) Assignee: embeX GmbH, Freiburg (DE)

(21) Appl. No.: 19/485,550

(22) PCT Filed: May 16, 2024
(86) PCT No.: PCT/EP2024/063493

§ 371 Date: Aug. 1, 2026

(30) Foreign Application Priority Data
May 19, 2023 (DE) 102023113202. 4

(51) Int. Cl. H02M 3/335; H02M 1/00; H02M 1/084; H02M 1/20; H02M 3/00; H02M 7/00; H02M 7/797

(52) U.S. Cl. CPC H02M 3/33584; H02M 1/0025; H02M 1/007; H02M 1/084; H02M 1/20; H02M 3/01; H02M 3/33573; H02M 7/003; H02M 7/797

(57) ABSTRACT

The application relates to a bidirectional n-phase electric converter device having the following features: input terminals for connecting a DC voltage source, a DC/DC converter which is connected to the input terminals and which comprises first switch elements, p intermediate circuits which are connected to the DC/DC converter on the output side, a DC/AC converter comprising second switch elements, wherein the DC/AC converter is connected downstream of the p intermediate circuits, and the DC/AC converter has output terminals for connecting an electric machine or an electric AC network, and a control device for actuating the second switch elements of the DC/AC converter such that a step-shaped n-phase output voltage can be provided. The DC/AC converter is designed as a base frequency-clocking rotor-controlled n-phase voltage system.

### CROSS-REFENCE TO RELATED APPLICATIONS

The present application is a 371 National Phase Application of International Patent Application No. PCT/EP2024/063493, filed May 16, 2024, which claims priority to German Patent Application No. 10 2023 113 202.4, filed May 19, 2023, the entirety of each of which is incorporated herein by reference.

### FIELD OF APPLICATION

The application relates to a bidirectional electric converter device.

### BACKGROUND

Bidirectional electric converters are well known from practice and are available in the most varied embodiments. For example, a DC voltage converter having a secondary resonant circuit capacitor is known from EP 3 713 066 A1. The DC voltage converter comprises a transformer, whereby a rectifier circuit and a resonant circuit are arranged on the primary side, and an additional rectifier circuit and an energy store are arranged on the secondary side.

From CH 714 079 A2, a converter for potential-free transmission of electrical power is known, disclosing an isolated two-stage pulse rectifier. In the first stage, a dual active bridge converter is provided. The dual active bridge comprises a full bridge on each of the primary and secondary sides, the bridges being connected to each other via a transformer. The dual active bridge is a DC/DC converter, meaning that a DC signal is present on both the input and output sides of the dual active bridge. The second stage of the two-stage pulse rectifier comprises a rotating current bridge circuit that drives a three-phase machine.

The problem with these electric converters, in particular when operating electric machines, is that both large dU/dt on the supply line to an electric machine and high-frequency current ripples on a sinusoidal current occur when using a PWM control, as it is typically used in rotating current bridge circuits. Both the large dU/dt and di/dt lead to high emitted interference of the drive system via the control line of the machine as well as to high-frequency leakage currents within the machine, which, in addition to EMC emissions, damage the properties of the ball bearings by micropitting. Due to the large dU/dt of the voltage signal, the demands on the machine's insulation system increase and the overall service life of the machine is reduced. In order to mitigate these effects, active and passive filters are generally used, but these significantly increase the installation footprint and costs of the overall system.

### SUMMARY

The disclosure described herein is based on the object to remedy this problem.

Hereinafter, unless stated otherwise, the bidirectional converter device is referred to as an electric converter device.

According to the embodiments of the present disclosure, an electric converter device thus comprises input terminals for connecting a DC voltage source and a DC/DC converter with first switch elements, the DC/DC converter being connected to the input terminals, where n is an integer greater than or equal to one. The converter device comprises p intermediate circuits connected to the DC/DC converter on the output side, where p is an integer greater than or equal to one. In addition, the electric converter device includes a DC/AC converter having second switch elements, where the DC/AC converter is connected downstream of the p intermediate circuits. The DC/AC converter includes n output terminals for connecting the electric machine. In addition, a controller for controlling the second switch elements is provided, such that a step-shaped and rotor position dependent n-phase voltage signal can be provided and the DC/AC converter is designed as a fundamental-frequency-clocking rotor-controlled n-phase voltage system.

The electric converter device is designed such that power can flow from the input side to the output side and vice versa. When using the electric converter device, in particular for operating electric machines, a bidirectional flow of power is advantageous, because, when braking, it is possible to feed back kinetic energy to an energy store connected to the input side. In addition, in generator mode, the electric machine may supply the energy store or a power grid or other consumers via the electric converter device.

Advantageously, the electric converter device is configured to operate an n=3-phase electric machine. Compared to single-phase machines, three-phase machines offer a number of advantages. On the one hand, these mostly have higher power, higher efficiency, a smaller footprint, and better load distribution.

Furthermore in the present disclosure, the controller controls the first switch elements such that the output voltage of the DC/DC converter is adjusted such that an at least approximately sinusoidal voltage signal can be provided at the n output terminals.

In another embodiment, the output voltage of the DC/DC converter is adjusted within a limited amplitude range, where the limited amplitude range is between 0 and 50 percent of an intermediate circuit voltage, and, in another embodiment, the limited amplitude range is between 0 to one sixth of the intermediate circuit voltage.

In another embodiment, the second switch elements of the controller can be controlled according to an MSK method. The MSK method is described in the 2012 PhD thesis “Ein mechanisches Kommutierungsverfahren zum Betrieb von permanenterregten Synchronmaschinen aus einer Gleichspannungsquelle” by Tobias Theopold (nee Rösmann).

In another embodiment of the disclosure, the MSK control method has 12 switching states, where the switching states are rotor position dependent. It is an advantage of the MSK control that the second switch elements are switched only once per electric revolution.

In another embodiment, the control of the current and its torque depends on a rotor displacement angle Δε, wherein one respective rotor displacement angle Δε is stored for different speed-to-torque combinations in one or more look-up tables.

As already mentioned, the MSK method has a switching sequence that depends on the rotor position. Rotor-controlled n-phase voltage systems need as inputs a DC voltage, which is provided most often in the form of an intermediate circuit voltage, and a specified phase offset Δε, where the phase offset may also be referred to as a rotor displacement angle. The rotor displacement angle is the phase difference between the rotor-induced voltage and the rotor-controlled n-phase voltage system. The torque is a function of the rotor displacement angle. The torque and thus the power at a given speed are directly proportional to the argument of the rotor displacement angle of a cosine function. The rotor displacement angle is in a range between zero and 90 electrical angle degrees, where a rotor displacement angle of zero degrees does not produce any torque and a rotor displacement angle of 90 degrees produces maximal torque. The rotor displacement angle of 90 degrees represents an edge case and is referred to as a transition point. If the rotor displacement angle exceeds an angle of 90 degrees, the electric machine will become unstable and loses its equilibrium. The machine is operated in an unstable operating range. The electric rotor position is determined by the mechanical rotor position and the number of pole pairs.

Rotor-position-based control methods are mostly employed with permanent magnet synchronous machines. There, the control takes place in the so-called dq coordinate system, among other things. Here, the dq coordinate system is mostly aligned with the excitation flux, where, for permanent magnet synchronous machines, the amplitude of the excitation flux is in the d direction. For the detection of the d direction, the rotor position is determined. The q direction is perpendicular to the d direction. In operation, the dq coordinate system rotates with the position of the rotor. Aside from the dq coordinate system, a coordinate system with respect to the stator, also referred to as of coordinate system, is used in control methods. The α direction of the αβ coordinate system is usually aligned with the first winding axis. The β direction is perpendicular to the a direction.

The control of the electric converter device is primarily carried out by means of a digital controller. The control of the electric converter device is significantly influenced by the switching behavior of the switch elements. The first switch elements and the second switch elements are controlled as a function of current, voltage, rotor position, and time. The control of the first switch elements and the second switch elements is coordinated by a controller. A voltage measurement is performed at the input terminals of the rotating current bridge circuit on the input side of the DC/DC converter. The measured voltage is transmitted to the controller. In addition, a voltage measurement is performed at the one or more intermediate circuits. The intermediate circuit voltage measured across the intermediate circuit capacitors is also transmitted to the controller. The electrical phase current of the electric machine is measured by a current measurement and transmitted to the controller. The rotor position is detected by means of a rotor bearing detection and transmitted to the controller.

The controller controls the second switch elements of the DC/AC converter in a manner according to the MSK method. The generated output voltage of the DC/AC converter is actively controlled by the high-performance DC/DC converter serving as an actuator. This allows controlling the amplitude of the stator current by controlling the stator voltage and thereby also allows controlling the torque.

Torque and phase current are interdependent. A larger phase current results in a higher torque and vice versa. If, as contemplated in the present exemplary embodiment, a permanent magnet synchronous machine is used, an angle is established between the rotor-induced voltage and the rotor-controlled n-phase voltage system, depending on the operating conditions. This angle is referred to as rotor displacement angle and is load independent. The rotor-induced voltage is defined as the voltage induced in the stator winding by the energized rotor. Both the speed and torque behaviors can be actively influenced over a wide operating range using a corresponding look-up table.

The electric machine may also be controlled by means of the so-called rectangular-wave method. By controlling the current in a specific way, a rectangular current is induced into the windings of the machine, whereby only two phases carry a current in a three-phase machine. The control of the phases depends on the rotor position. The rotor passes through an electrical angle, whereby the current is electrically commutated to the next phase every sixty electrical angle degrees. In this control method, the amplitude of the output phase and thus the magnitude of the amplitude of the output current is specified by the magnitude of the intermediate circuit voltage. This control method results in an unwanted common mode voltage, which must be dissipated.

The rectangular-wave method has a relatively simple control structure. This includes, for example, a cascade control system, which has an inner and outer control loop. The outer speed control loop comprises an inner current control loop subportion. The current controller outputs a voltage setpoint that sets the power switches of an inverter circuit. Phase current values and rotor position are determined and, if necessary, passed to the corresponding control loops as actual values by means of differentiation or integration. The control structures of both control loops are designed with negative feedback. The actual values are subtracted from the setpoints, which results in the corresponding control value.

Another control method for controlling the electric machine is pulse width modulation. In this process, the semiconductors are repeatedly switched on and off hard over one electrical period, resulting, on average, in an approximately sinusoidal output signal. In an embodiment, the output current can be controlled directly, which leads to high performance of the electric converter device.

In another embodiment, a combination of MSK and PWM methods may be used to control the electric converter device. In this case, the PWM method is used when starting up or at low speeds, and the MSK method is used when speeds increase. With a number of pole pairs of one and a maximum speed of 3000 rpm, a combination of both control methods would mean that the PWM method is used up to about ten percent of the maximum speed, that is, about 300 rpm, and the MSK method is used for speeds higher than that.

According to another embodiment of the present subject matter, the electric machine includes a mechanical commutation device. The mechanical commutation device may be realized by means of brushes or collector rings. Mechanical commutation devices are characterized by a robust and inexpensive design. The controller does not require complex electronics, which increases reliability.

In another embodiment, the p intermediate circuits are designed as capacitive intermediate circuits. Here, capacitive intermediate circuits are less susceptible to interference than inductive intermediate circuits. This reduces electromagnetic interference. Furthermore, capacitive intermediate circuits have a fast response time, allowing them to react quickly to changes in the load. Capacitive intermediate circuits are used in applications where rapid control is required. Capacitive intermediate circuits typically have lower losses, a smaller footprint, and lower costs than inductive intermediate circuits. The intermediate circuit capacitor or capacitors are charged when the electric converter device is started up.

In another embodiment, the capacitive intermediate circuit is realized by one or more capacitors. It is recommended to connect capacitors with different ESR values in parallel. For example, it is recommended to connect a high ESR capacitor in parallel with a low ESR capacitor. In electric converter devices electrolytic capacitors, ceramic capacitors, and film capacitors are usually connected in parallel to each other. Electrolytic capacitors typically have a higher ESR value than film capacitors or ceramic capacitors. In contrast to electrolytic capacitors, which have a liquid as a dielectric, ceramic capacitors have a ceramic dielectric, and film capacitors have layered metal films as a dielectric, respectively. The fluid of the electrolytic capacitor has greater resistance and thus a larger ESR value. While electrolytic capacitors are usually used as energy buffers, ceramic capacitors and film capacitors are used to filter out the high-frequency component of the current.

In addition, the intermediate circuit may be formed from an arrangement of capacitive and inductive impedances. The impedances are connected in a CLC arrangement, whereby the CLC arrangement forms a first capacitance connected in parallel with the rectifier. An inductance connects the first and a second capacitance that is also connected in parallel with the rectifier. This specific impedance arrangement will be referred to hereinafter as a decoupling filter. The decoupling filter exhibits better common mode rejection than a single intermediate circuit capacitor. In a simple intermediate circuit capacitor, the neutral conductor jumps back and forth between different potentials, which leads to increasing common mode noise. Another possibility to make the intermediate circuit less sensitive to common mode noise is two connect two intermediate circuit capacitors in series. The neutral conductor is connected between the two intermediate circuit capacitors that are connected in series. The intermediate circuit voltage is clamped to a specific voltage value.

In addition, in the disclosure, the switching frequency of the first switch elements is in the range of from about 500 kHz to about 1 MHz.

According to another embodiment, the DC/DC resonant converter comprises a three-phase high-frequency transformer. An advantage of high-frequency transformers is that they require significantly less installation space than low-frequency transformers for the same power. In addition, high-frequency transformers are typically more efficient. High-frequency transformers have lower stray magnetic fields. This is particularly advantageous in sensitive applications. The high-frequency transformer is preferably designed as a planar transformer. Planar transformers typically have a smaller footprint than conventional transformers because the windings are arranged flat in a plane. Additionally, planar transformers exhibit less leakage inductance. This results in better efficiency and reduces electromagnetic interference. Cooling of the high-frequency transformer is easier to realize by the planar construction, by attaching the planar transformer to one or more heat sinks.

In another embodiment, the high-frequency transformer is designed as a delta-wye-transformer, whereby the primary side of the high-frequency transformer is connected in a delta connection and the secondary side of the high-frequency transformer is connected in a wye connection.

In another embodiment, the DC/DC resonant converter is designed as a CLLC topology, whereby the CLLC topology includes two capacitances and two inductances of the high-frequency transformer. The impedances of the CLLC topology are designed to enable zero voltage switching (ZVS) or zero current switching (ZCS) over the largest possible frequency range and, on both the input and output sides, the widest possible voltage range, in order to reduce switching losses. In ZVS, the semiconductors are switched at the voltage zero crossing, which ideally results in no power loss. In ZCS, the semiconductors are switched at the current zero crossing. Here, too, no power loss occurs in an idealized case.

In another embodiment, the arrangement of the impedances of the CLLC topology first comprises a capacitance, followed by two inductances and a subsequent additional capacitance. In general, DC/DC CLLC converters are characterized by a high efficiency of up to 99 percent.

In another embodiment, the controller is configured to control the first and second switch elements as a function of current, voltage, rotor position, and time.

According to another embodiment of the present disclosure, the DC/DC converter in the three-phase system includes a rotating current bridge circuit on the input side. The rotating current bridge circuit, also referred to as B6C bridge, is characterized by a simple design and has proven itself in practice as a reliable inverter circuit. In the single-phase system, the DC/DC converter includes full bridges on the input and output sides. In addition to two-level inverter topologies, three-level inverter topologies such as the neutral point clamped inverter or the flying capacitor inverter, as well as multi-level inverter topologies may also be used.

In another preferred embodiment, the rotating current bridge circuit of the DC/DC converter includes three half bridges each on the input and output sides, with each half bridge including two switch elements. In the single-phase system, both the inverter circuit of the DC/DC converter on the input side and the rectifier circuit of the DC/DC converter on the output side include two half bridges each.

Furthermore, in another embodiment, the first switch elements are designed as silicon carbide (SIC) or gallium nitride (GaN) power switches, for example as MOSFETs. Semiconductors of silicon carbide are characterized by their high electric strength. In addition, higher switching frequencies are possible than with conventional silicon semiconductors. In general, silicon carbide semiconductors exhibit lower losses, higher temperature resistance, and a lower RDSon than conventional silicon semiconductors. Gallium nitride semiconductors are used primarily in high switching frequency applications. The switching losses with GaN semiconductors are significantly lower than with conventional silicon semiconductors.

In another embodiment, the second switch elements are designed as IGBTs or MOSFETs. At lower switching frequencies, it is recommended to use conventional silicon-based MOSFETs or IGBTs, as these offer significant cost advantages over SIC or GaN semiconductors.

In another embodiment, the DC/DC converter and the DC/AC converter are arranged in a common electrically conductive housing. The housing is preferably made of metal. A metallic housing improves the electromagnetic compatibility of the overall system. Metal housings can shield against electromagnetic interference emanating from or affecting the components inside. The metal housing also provides protection against external influences such as moisture and dirt. In addition, metal housings are more robust and resistant against external influences than plastic housings.

According to the present disclosure, in another embodiment, a method for operating an electric converter device is described, wherein the electric converter device controls, by means of a controller, at least one DC/DC converter via first switch elements and at least one DC/AC converter via second switch elements, wherein the second switch elements of the DC/AC converter are controlled such that the at least one output voltage of the DC/AC converter is pulse-shaped, wherein the at least one output voltage of the DC/DC converter is adjusted between pulses of the output voltage of the DC/AC converter such that a quasi-sinusoidal phase current is formed at the output of the electric converter device.

In another embodiment of a method for operating an electric converter device, the second switch elements of the DC/AC converter are controlled according to the MSK method, wherein the MSK method forms a twelve-pulse output voltage at the output of the electric converter device.

In another embodiment of a method for operating an electrical converter device, the DC/DC converter is the actuator of the rotor-controlled n-phase voltage system, whereby the amplitude of the phase current is controlled by the DC/DC converter.

In another embodiment of a method for operating an electrical converter device, the torque is controlled by the phase shift between the rotor-induced voltage and the rotor-controlled n-phase voltage system.

In another embodiment, the electric converter device is used for operating electric machines.

In another embodiment, the electric converter device is used for supplying an electric AC grid.

### BRIEF DESCRIPTION OF THE DRAWINGS

The following will explain three exemplary embodiments with the following figures. In the first exemplary embodiment, a three-phase electric machine is controlled by a DC/AC converter, which is fed via p=3 intermediate circuits. In the second exemplary embodiment, a three-phase electric machine is controlled by a DC/AC converter, which is fed via p=1 intermediate circuit. In the third exemplary embodiment, the electric machine is operated in generator operation and feeds into an electric three-phase grid.

FIG. 1 shows an equivalent circuit diagram of the electric converter device comprising a three-phase DC/DC converter, three intermediate circuits, a three-phase DC/AC converter, a controller, and an electric machine.

FIG. 2 shows an equivalent circuit diagram of the electric converter device comprising a single-phase DC/DC converter, an intermediate circuit, a three-phase DC/AC converter, a controller, and an electric machine.

FIG. 3 shows an equivalent circuit diagram of the electric converter device comprising a single-phase DC/DC converter, an intermediate circuit, a three-phase DC/AC converter, and a controller.

FIG. 4 shows a block diagram of the controller of the electric converter device comprising three sections, namely, a drive control, a motor control, and power electronics.

FIG. 5 shows the switching table of the MSK controller.

FIG. 6 shows an output voltage signal of a phase having 12 switching states illustrated by way of example. In addition, an adjusted output voltage of a phase of the DC/DC converter is shown as a function of time.

FIG. 7 shows a phase current in an electric machine as a function of time.

### DETAILED DESCRIPTION

In the following figures, identical reference numerals denote identical parts with the same meaning.

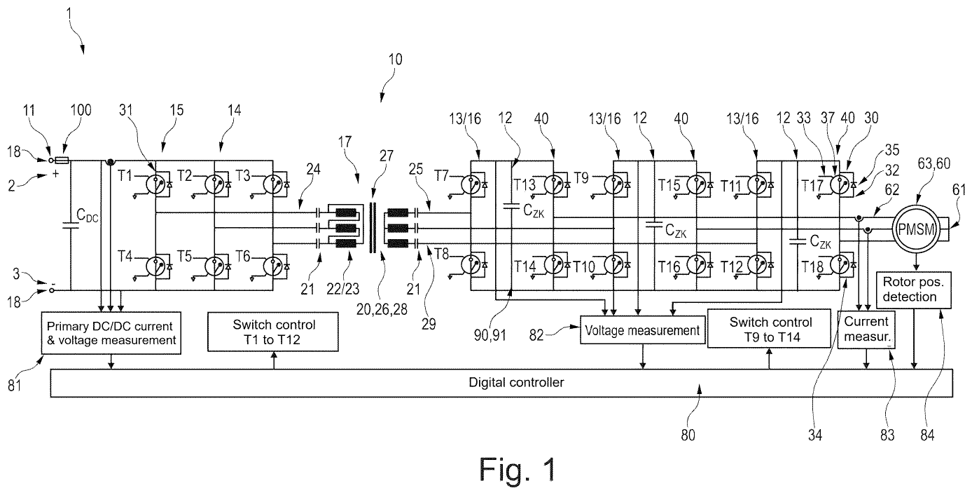

The first exemplary embodiment of the electric converter device will be explained in greater detail by way of FIG. 1.

The electric converter device 1 of the first exemplary embodiment includes a three-phase DC/DC converter 10, three intermediate circuits 90, a three-phase DC/AC converter 40, a controller 80, and an electric machine 60.

The DC/DC converter 10 has a DC input side 11 and a DC output side 12. The DC input side 11 of the DC/DC converter 10 is supplied by an energy store or an AC power grid or a DC power grid (none of the three shown) at the input terminals 22 of the DC/DC converter 10. The DC/DC converter 10 is designed as a three-phase, highly efficient DC/DC resonant converter 17. The DC/DC converter 10 includes a DC/AC converter 14 on the input side, the DC/AC converter 14 being designed as a rotating current bridge circuit 15. On the output side, the DC/DC converter 10 includes an AC/DC converter 13, which converts an alternating signal into a DC signal. Between the rotating current bridge circuit 20 on the input side and the AC/DC converter 13, a three-phase high-performance high-frequency transformer 20 is implemented, to which capacitances 21 and inductances 22 are connected upstream or downstream on the input and output sides. In addition, a fuse 100 is connected upstream of the DC/DC converter 10, which trips in case of a fault and switches off the electric converter device 1. Alternatively, the electric converter device 1 can be safely switched off by activating the switch elements 30 accordingly, whereby the electric converter device includes first switch elements 31 and second switch elements 32. The DC/DC converter 10 includes the first switch elements 31, and the DC/AC converter 40 includes the second switch elements 32.

The input-side rotating current bridge circuit 15 of the DC/DC converter 10 forms three half bridges 36, each of which includes two first switch elements 31. The two first switch elements 31 of a half bridge 36 are connected in series with one another, whereby the first switch element 31 of a half bridge 36 connected to plus 2 is referred to as the upper switch element 33, and the first switch element 31 connected to minus 3 is referred to as the lower switch element 34.

The first switch elements 31 are preferably designed as MOSFETs. The semiconductor material of the first switch elements 31 is preferably silicon carbide or gallium nitride. Due to their topology, MOSFETs consist of a switch 37 and a body diode 35 arranged anti-parallel to the switch 37. If the properties of the body diode 35 are insufficient for the intended application, it is recommended to arrange another diode anti-parallel to the switch 37 so that the required characteristics for the switch element 30 are met.

MOSFETs have a drain, a source, and a gate terminal. When an external voltage is applied to the gate terminal of the MOSFET, the voltage between gate and source changes and the resistance between drain and source decreases. The switch element 30 opens. If the external voltage previously applied to the gate terminal is removed, there is no voltage between gate and source, and the resistance between drain and source increases. The switch element 30 closes. Due to the intended high switching frequencies, it is recommended to use first switch elements 31 that have a small RDSon in order to keep switching losses as low as possible. RDSon refers to the minimum on-state or turn-on resistance of a MOSFET.

The first switch elements 31 of the input-side rotating current bridge circuit 15 of the DC/DC converter 10 convert a DC signal at the input terminals 19 of the DC/DC converter 10 into a high-frequency alternating signal. The high-frequency alternating signal is transmitted via a high-frequency transformer 20. The high-frequency transformer 20 has a transformation ratio of one, but may also have a transformation ratio different from one, e.g. 7/4.

The high-frequency transformer 20 has a primary side 24 and a secondary side 25. Due to its topology, the high-frequency transformer 20 has a galvanic isolation 27 between the primary side 24 and the secondary side 25. This means that the DC input side 11 is galvanically isolated from the electric machine 60, which means that the reference voltages of both subsystems differ and interference signals are reduced.

The high-frequency transformer 20 is preferably operated in a frequency range between 500 kHz and 1 MHz. The high-frequency transformer 20 may also be operated in a smaller or larger frequency range. The higher the frequency at which the high-frequency transformer 20 is operated, the smaller the footprint of the high-frequency transformer 20 at the same power transfer. The high-frequency transformer 20 is designed as a three-phase transformer 26. Compared to three interconnected single-phase transformers, the three-phase transformers 26 are smaller, cheaper, and lighter, because the copper and iron core is used more efficiently. Particularly preferably, the high-frequency transformer 20 is designed as a three-phase planar transformer 28. The planar transformers 28 are designed either as a single component or integrated on a common circuit board.

The high-frequency transformer 20 is preferably designed as a delta-wye-transformer. Here, the primary side 24 of the high-frequency transformer 20 is connected in a delta connection and the secondary side 25 of the high-frequency transformer 20 is connected in a wye connection.

The DC/DC converter 10 is preferably designed as a DC/DC resonant converter 17. The DC/DC resonant converter 17 has a CLLC topology. In the embodiment shown in FIG. 1, the CCLC topology is configured such that a capacitance 21 followed by an inductance 22 is connected to the primary side 24 of the high-frequency transformer 20. The secondary side 25 of the high-frequency transformer 20 includes a further inductance 22 with a series-connected capacitance 21 based on the topology-induced galvanic isolation. The two inductances 22 of the CLLC topology may be the leakage inductances 23 of the high-frequency transformer 20, or additional inductances 22 may be connected in series with the leakage inductance 23 of the high-frequency transformer 20 in addition to the topology-induced leakage inductances 23 of the high-frequency transformer 20.

The inductances 22 and capacitances 23 of the CLLC topology form a series resonance. If the resonant frequency of the series resonance is higher than the switching frequency of the first switch elements, the first switch elements 31 can be switched on and off virtually without loss. Preferably, the first switch elements 31 switch on and off without loss. For this purpose, the first switch elements 31 are controlled in such a way that they use the zero voltage switching or zero current switching methods or both methods simultaneously.

In zero current switching, the switch element 30 is switched on or off at the zero current crossing. In zero voltage switching, the switch element 30 is switched on or off at the zero voltage crossing. If both zero voltage switching and zero current switching are used in a switching process, the switch element 30 is switched on or off both at the zero current crossing and at the zero voltage crossing. The power loss of a switching process results from the product of current and voltage applied during the switching process. If either the current, or the voltage, or both the current and the voltage are zero at the time of switching, the power loss of the switching process is zero as well.

An AC/DC converter 13 is connected downstream on the secondary side 25 of the high-frequency transformer 20. The AC/DC converter 13 preferably is designed as a rotating current bridge circuit 16. Each output-side phase 29 of the high-frequency transformer 20 is connected to a half bridge 36 of the output-side rotating current bridge circuit 16 of the DC/DC converter 10. The output-side phases 29 of the high-frequency transformer 20 are connected between the upper switch elements 33 and lower switch elements 34 of the first switch elements 31 of a half bridge 36. An intermediate circuit capacitor 91 is connected downstream of each half bridge 36. The first switch elements 31 of the output-side rotating current bridge circuit 16 of the DC/DC converter 10 are controlled such that the currents cancel each other out. The intermediate circuit capacitor 91 maintains the intermediate circuit voltage at a predefined voltage value. In the first exemplary embodiment, the electric converter device 1 includes three intermediate circuit capacitors 91 and thus three intermediate circuits 90.

At very high operating voltages, it is advisable to connect several intermediate circuit capacitors 91 in series and thereby achieve the required electric strength. By connecting the intermediate circuit capacitors 91 in series, the total capacitance of the intermediate circuit capacitors 91, which are connected in series, is reduced by a factor of 1/z, where z is the number of intermediate circuit capacitors 91 connected in series. The intermediate circuit 90 preferably includes an electrolytic capacitor and a ceramic capacitor and/or a film capacitor, the electrolytic capacitor being arranged in parallel to the ceramic capacitor and/or the film capacitor. The electrolytic capacitor serves as an energy buffer, while the ceramic capacitor and/or film capacitor compensates for the high-frequency current ripple and thus maintains the intermediate circuit voltage at an approximately constant value. The intermediate circuit capacitors 91 are connected to each other on the negative side.

A half bridge 36 is connected downstream of each intermediate circuit capacitor 91. The half bridge 36 connected downstream of the intermediate circuit capacitor includes second switch elements 32. The three half bridges 36 connected downstream of the intermediate circuit capacitors 91 are components of the DC/AC converter 40. Each half bridge 36 connected downstream of an intermediate circuit capacitor 91 is connected to a phase 62 of the electric machine 60.

The second switch elements 32 are preferably designed as IGBTs or MOSFETs. The second switch elements 32 switch much more slowly than the first switch elements 31. The half bridges 36 connected downstream of the intermediate circuit capacitors 91 control the individual phases 62 of the electric machine 60. In contrast to MOSFETs, if IGBTs are used as the switch elements 30, a diode must necessarily be connected anti-parallel to the switch 37, since the topology-induced body diode 35 of a MOSFET is not present in IGBTs.

The electric machine 60 is particularly preferably designed as a permanent magnet synchronous machine 63. Permanent magnet synchronous machines 63 include permanent magnets in the rotor. As a result, the rotor is always magnetized and the rotor does not need to be magnetized via the stator, as is the case with asynchronous machines or reluctance machines. In particular, magnetizing the rotor across a large air gap leads to significant losses. Therefore, permanent magnet synchronous machines 63 are characterized by a higher efficiency and a higher power density compared to asynchronous machines and reluctance machines.

Permanent magnet synchronous machines 63 can include magnets embedded in the rotor (IPM) or surface-mounted magnets. The different designs of the permanent magnet synchronous machine cause different magnetic conductances to develop in the d direction and the q direction, resulting in different inductances Ld and Lq in the d direction and the q direction. For permanent magnet synchronous machines 63, Ld is not equal to Lq, where Ld is smaller than Lq, and for a rotationally symmetric rotor with surface magnets, Ld=Lq. The general torque consists of a reluctance torque, which is formed by the different inductances in the d direction and the q direction in conjunction with the phase currents, and a synchronous torque, which is formed by the permanent field in conjunction with the phase currents. The three phase currents are converted into the dq coordinate system for simplified control handling.

In permanent magnet synchronous machines, where Ld=Lq, no reluctance torque is formed, thus it is recommended to use only the iq current in base speed operation, with the id current being regulated to zero. In the field-weakening range, a negative id current is applied, which weakens the field, reduces the induced voltage in the phase windings, and thus allows higher rotational speeds at the same voltage. The disadvantage is the lower torque output.

For permanent magnet synchronous machines where Ld is less than Lq, for example, MMPA optimization is used in the base speed range, whereas MMPV optimization is used in the field-weakening range.

In another embodiment, the electric machine is designed as a separately excited synchronous machine. The separately excited synchronous machine includes an excitation winding in the rotor. The excitation winding makes the separately excited synchronous machine easy to control, since the magnetization of the rotor can easily be controlled via the current supplied to the excitation winding.

The control of the separately excited synchronous machine is similar to that of the permanent magnet synchronous machine, except that the current control is based on the main flux rather than the excitation flux. The state of the main flux is calculated by means of a current-voltage model.

In another embodiment, the electric machine is designed as a reluctance machine. In general, reluctance machines are classified as either synchronous reluctance machines or switched reluctance machines. For both topologies, the reluctance machine is characterized by an extremely robust design and low manufacturing costs. Furthermore, the reluctance machine is usually operated at very high speeds, which generally results in a higher power density compared to an asynchronous machine.

The three electrical phases 62 of the electric machine 60 are interconnected in a wye connection 61. However, the phases 62 may also be connected in a delta connection. In the wye connection 61, the switch elements 30 of the electric converter device 1 must be controlled such that the currents in the neutral conductor compensate.

The electric converter device 1 measures current and voltage values in relevant regions. A current and voltage measurement 81 is performed at the DC input side 11 and transmitted to a controller 80. In addition, a voltage measurement 82 is performed at the three intermediate circuits 90 and is also transmitted to the same controller 80. At the phases 62 of the electric machine 60, a current measurement 83 is performed. The current determined by the current measurement 83 and the rotor position, which is determined by a rotor position detection 84, are transmitted to the controller 80.

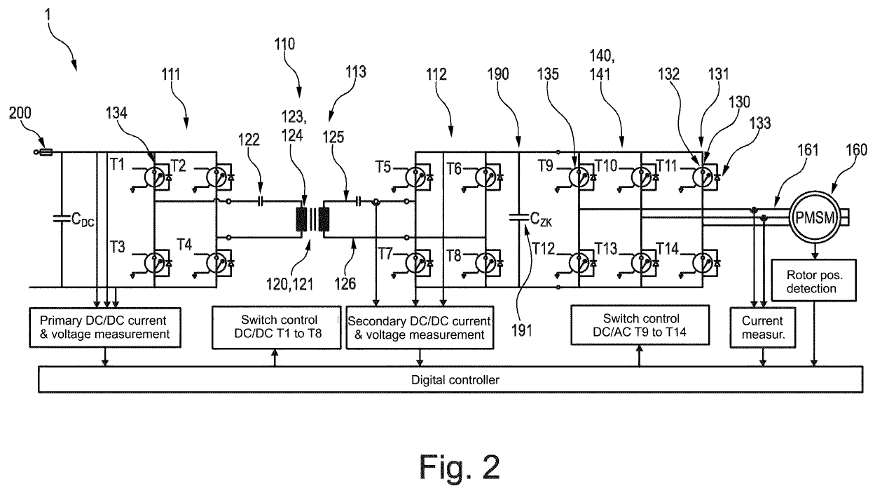

FIG. 2 shows an electric converter device 1 that includes a single-phase DC/DC converter 110, an intermediate circuit 190, a three-phase DC/AC converter 140, a controller 180, and an electric machine 160.

The DC/DC converter 110 is connected to a power source on the input side. The power source may be a battery or an AC/DC power supply or a DC/DC power supply. Between the power source and the DC/DC converter 110, a fuse 200 is connected, which securely disconnects the electric converter device 1 from the power supply in case of a fault.

The DC/DC converter 110 is preferably designed as a single-phase converter. The DC/DC converter 110 includes a full bridge 111 on the input side and a full bridge 112 on the output side with first switch elements 134. A transformer 120 is implemented between the two full bridges 111-112. The transformer 120 is preferably designed as a high-frequency transformer 121. A full bridge 111-112 includes four switch elements 130. The switch elements 130 are arranged in half bridges 136. A half bridge 136 consists of two switch elements 130 interconnected in series. Each switch element 130 includes a switch 132 and a diode 133 arranged anti-parallel to the switch 132. A full bridge 111-112 includes two half bridges 131 connected in parallel to each other. The first switch elements 134 of the input-side full bridge 111 convert a DC signal into a high-frequency AC signal, whereas the output-side full bridge 112 converts the high-frequency AC signal into a DC signal. The advantage of high-frequency AC signals is that the high-frequency transformer 121 has a higher efficiency and a smaller footprint at the same power than is the case with low-frequency AC signals.

The first switch elements 134 are preferably designed as MOSFETs and use gallium nitride or silicon carbide as semiconductor materials. The switching frequency of the first switch elements 134 of the two full bridges 111-112 of the DC/DC converter 110 preferably is between 500 kHz and 1 MHz. However, the switching frequency of the first switch elements 134 may also be in a smaller or larger frequency range.

A high-frequency transformer 121 is connected between the two full bridges 111-112 of the DC/DC converter 110. The high-frequency transformer includes 121 impedances on the input and output side. The impedances on the input and output sides are each a capacitance 122 and an inductance 123, where the inductance 123 may be the leakage inductance 124 of the high-frequency transformer 121. Thus, the DC/DC converter 110 is preferably designed as a DC/DC resonant converter 113 in a CLLC topology.

The high-frequency transformer 121 is connected on the supply line 125 between two first switch elements 134 of one half bridge 131 of a full bridge 111-112. The return line 126 of the high-frequency transformer is connected between the two first switch elements 134 of the other half bridge 131 of a full bridge 111-112.

On the output side, the DC/DC converter 110 is connected to a capacitive intermediate circuit 190. The capacitive intermediate circuit 190 is realized by means of an intermediate circuit capacitor 191. The intermediate circuit capacitor 191 may be realized by means of several intermediate capacitors 191 arranged in series or in parallel to one another. Preferably, electrolytic capacitors, film capacitors, and ceramic capacitors are used. The intermediate circuit 190 serves as an energy buffer and filters out the high-frequency current component.

A DC/AC converter 140 is connected downstream of the intermediate circuit capacitor 191, the DC/AC converter 140 being designed as a rotating current bridge circuit 141. The rotating current bridge circuit 141 has three half bridges 131, each with two second switch elements 135. The second switch elements 135 are designed as IGBTs or MOSFETs. The switching frequency of the second switch elements 135 is significantly lower than that of the first switch elements 134 and is approximately in the triple-digit frequency range. However, the switching frequency may also be in a larger or smaller frequency range.

The rotating current bridge circuit 141 controls the individual phases 161 of the electric machine 160. The MSK method, the rectangular-wave method, the PWM method, or a combination of the aforementioned methods may be used as the control method.

The first switch elements 134 and second switch elements 135 are controlled by the controller 180. For this purpose, voltage values, current values, and the rotor position are detected and fed to the controller 180. The controller 180 controls the second switch elements 135 of the rotating current bridge circuit 141 such that a twelve-pulse voltage signal is generated. In addition, the controller 180 controls the first switch elements 134 of the DC/DC converter 110 such that the output voltage of the DC/DC converter 110 is adjusted so that the output voltage of the DC/DC converter 110, together with the output voltages of the rotating current bridge circuit 141, produce a quasi-sinusoidal current waveform in the phases 162 of the electric machine 160.

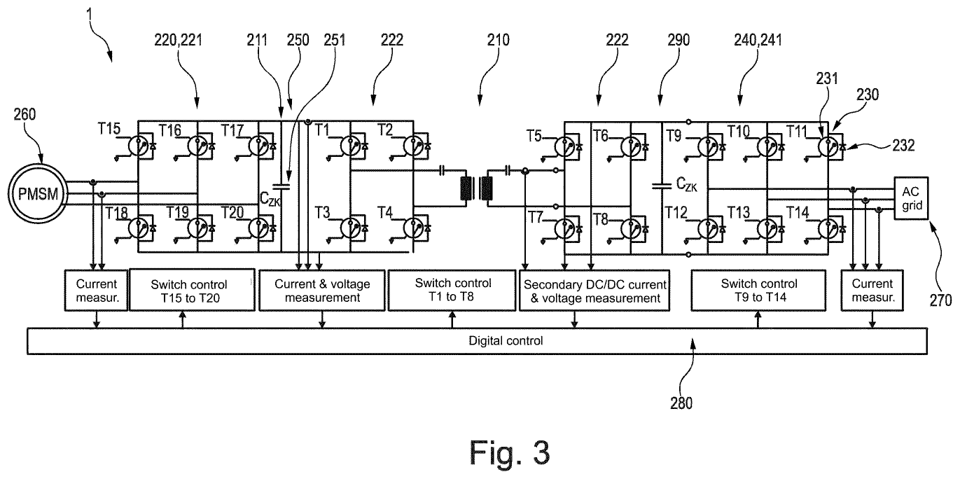

FIG. 3 shows the third exemplary embodiment of the electric converter device 1 including a single-phase DC/DC converter 210, two intermediate circuits 290, a three-phase DC/AC converter 240, and a controller 280. The three-phase DC/AC converter 240 is designed as a rotating current bridge circuit 241, here the rotating current bridge circuit 241 is connected to a three-phase AC grid 270. However, the AC grid 270 may also be a single-phase grid, whereby the DC/AC converter 240 is preferably designed as a full bridge. An intermediate circuit 250 is implemented between the rotating current bridge circuit 221, which is connected to the electric machine, and the DC/DC converter 210. The other intermediate circuit 290 is implemented between the rotating current bridge circuit 241, which is connected to the AC grid 270, and the DC/DC converter 210.

In this exemplary embodiment, the electric converter device 1 is identical to the electric converter device 1 of exemplary embodiment two, but may also correspond to the electric converter device 1 of exemplary embodiment one.

In contrast to the exemplary embodiments described above, in exemplary embodiment three, an electric machine 260 is preferably connected to the DC input side 211 of the DC/DC converter 210 via a DC/AC converter 220. Preferably, an intermediate circuit capacitor 251 is connected between the DC/DC converter 210 and the DC/AC converter 220, which is connected to the electric machine 260. Preferably, a three-phase electric machine 260 is used, such that the DC/AC converter 220 is preferably designed as a rotating current bridge circuit 220. The switch elements 230 of the rotating current bridge circuit 220 have a maximum switching frequency of several hundred Hertz. The switch elements 230 are preferably designed as IGBTs or MOSFETs and are comprised of a switch 231 and a diode 232 anti-parallel to the switch 231. A single-phase electric machine 260 may also be used, which is connected to an intermediate circuit 250 via a full bridge 222.

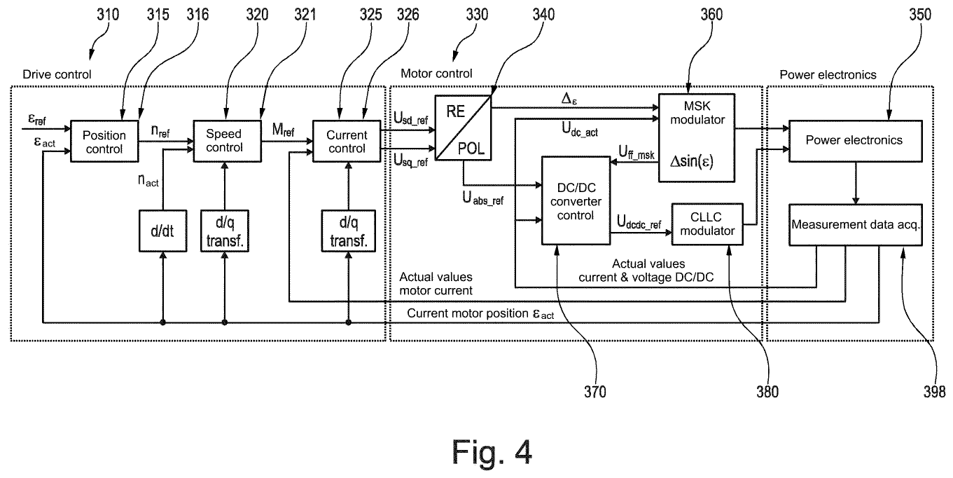

FIG. 4 shows the control via a controller 80; 280 of the electric converter device 1 in a block diagram. The control is similar for the three aforementioned example applications.

The controller 80; 280 can be divided into three subsections. The subsections are a drive control 310, a motor control 330, and power electronics 350 with measurement data acquisition 390. The power electronics 350 controls the electric machine. The measurement data acquisition 390 measures voltages, currents, and the rotor position and transmits the values to a control unit.

The drive control 310 is a cascade controller with three control loops. A distinction is made between the outer control loop 316 of the position control 315, the middle control loop 321 of the speed control 320 and the inner control loop 326 of the current control 325.

The position setpoint ε_{ref} and the actual position ε_{act} are passed to the outer control loop 316 that performs the position control 315. The actual position ε_{act} may be determined by means of a rotor position detection 84. The actual position ε_{act} and the position setpoint ε_{ref} are subtracted from each other. Since experience has shown that no disturbances affect this control loop, it is recommended that the position controller 315 be designed as a P controller. The output value of the position controller 315 is the speed setpoint n_{ref} of the speed controller 320.

The speed control 320 forms the middle control loop 321. The speed setpoint n_{ref} of the position controller 315 is passed to the speed control 320. The actual speed n_{act} is determined from the change of the motor position angle and is also passed to the speed control 320. The middle control loop 321, like all three control loops, includes negative feedback. This means that the actual value is subtracted from the setpoint. It is recommended to design the speed controller 320 as a PI controller. The I portion is needed to compensate for the disturbance load torque. The output value of the speed controller 320 is the torque setpoint M_{ref} of the current controller 325.

The current control 325 forms the inner control loop 326. On the input side, the torque setpoint M_{ref} and the actual currents are passed. It is recommended to convert the actual currents into the dq coordinate system before passing them to the inner control loop 326. There, the current is determined for each or at least two phases of the electric machine, for example using a Rogowski coil. Subsequently, the three phase currents 62; 161 are converted to the dq coordinate system by means of the Park transformation. Here, it is recommended to control the id and iq currents independently of each other. For this purpose, the two controlled systems of the d component and the q component are decoupled by means of feedforward control of the coupling terms. The current control 325 includes the voltages U_{sd_ref} and U_{sq_ref} as output values.

The output voltages U_{sd_ref} and U_{sq_ref} of the current controller 325 are transferred to a Cartesian-polar converter 340. The Cartesian-polar converter 340 converts the voltages U_{sd_ref} and U_{sq_ref} that are given in the Cartesian coordinate system into polar coordinates. In the polar coordinate system, a vector in voltage space is specified with an amplitude and an angle. The Cartesian-polar converter 340 outputs the rotor displacement angle Δε and a voltage amplitude U_{abs_ref}. The rotor displacement angle Δε is the phase shift between rotor-induced voltage and the rotor-driven polyphase voltage system.

The current intermediate circuit voltage U_{dc_act} and the rotor displacement angle Δε and the current rotor position & are passed to the MSK modulator 360, which outputs the DC/AC output voltage 420. The MSK modulator 360 controls the corresponding switch elements 30; 130; 230, as the name suggests, according to the MSK method. The power required at each operating point depends on the speed and torque. At a given speed, the current and thus the torque is controlled by the rotor displacement angle Δε. For different speed torque combinations, there are different rotor displacement angles Δε. The respective rotor displacement angles Δε may be stored in one or more look-up tables. By correspondingly varying the rotor displacement angle Δε, both the speed and torque behavior can be actively influenced over a wide operating range. Real-time calculation can be significantly reduced by means of the pre-calculated rotor displacement angles Δε.

The voltage U_{abs_ref} as well as the current voltages of the DC/DC converter 10; 110; 210 as well as the output voltages 420 of the DC/AC converter at the terminals of the electric machine, which the MSK modulator 360 sets via the second switch elements 32; 135 of the DC/AC converter 10; 110; 210, are passed to the DC/DC controller 370. The DC/DC controller 370 passes the voltage setpoints of the DC/DC converter U_{dcdc_act} to the CLLC modulator 380. Subsequently, the first switch elements 31; 134 are switched such that the voltages at the output of the DC/DC converter 10; 110; 210 are adjusted such that a quasi-sinusoidal current waveform in the phases of the electric machine 60; 160; 260 or the electrical AC grid 270 results by superposition with the output voltage 410 of the DC/AC converter 40; 140; 240. The adjusted voltage at the output 420 of the DC/DC converter 10; 110; 210, which is the intermediate circuit voltage, is adjusted within a limited amplitude range. The limited amplitude range is in the range between zero and fifty percent of the intermediate circuit voltage, with the limited amplitude range preferably being in a range between zero and one sixth of the intermediate circuit voltage.

The controller of the DC/DC converter 370 also has a cascade structure. An external voltage control loop is superimposed on the internal current control loop. Both the current controller and the voltage controller are preferably implemented as PI controllers. The DC/DC converter 10; 110; 210 serves as an actuator for the rotor-controlled polyphase voltage system. The control of the DC/DC converter 10; 110; 210 regulates and limits the current in the electric converter unit 1 and thus also in the electric machine 60; 160; 260.

In exemplary embodiment three, almost the same control topology is used as in exemplary embodiments one and two.

The control of the DC/AC converter 40; 140; 240, which is directly connected to the AC grid 270, ensures that exactly as much active power is supplied to the AC grid 270 as the electric machine 60; 160; 260 supplies on the input side; otherwise, the intermediate circuit voltage at the intermediate circuit capacitor 91; 191 changes, which is undesirable. The second switch elements 32; 135 are to be switched by the controller 80; 280 such that the intermediate circuit voltage remains nearly constant at a predefined setpoint. The current, which flows from the DC/AC converter 40; 140; 240 into the intermediate circuit capacitor 91; 191, will be referred to hereinafter as direct current. With a constant grid voltage and a constant intermediate circuit voltage, the direct current is proportional to the active current on the grid side. Instead of the direct current, it is possible to regulate the active current on the grid side by using the phase voltages as actuators. The reactive current results from the active current. In the equivalent circuit control diagram, the active current corresponds to the id current, and the reactive current corresponds to the iq current. In steady-state operation, the reactive current is regulated to zero, resulting in a power factor of one.

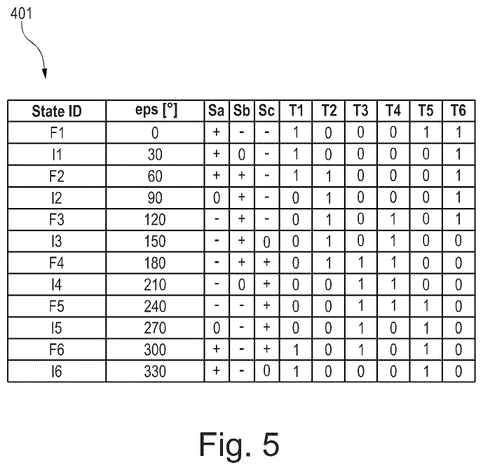

FIG. 5 shows the switching table 401 of the MSK control method. Each switch changes its switching state only once per electric revolution. The switching table 401 has eleven columns. The first column indicates the ID of the respective switching state. Among other things, a distinction is made between F state and I state. The switching states with the prefix F correspond to switching states of the fundamental frequency clocking with direct self-control, and the switching states with the prefix I correspond to switching states where one of the phases does not carry a current. A combination of the switching states with the prefix F and the switching states with the prefix I includes all switching states of the MSK method. The second column indicates, at which electric rotor angle the switching state changes. In this illustrated example switching sequence, the switching sequence begins at F1 and ends at I6. The switching state changes every 30 electrical angle degrees. Columns three to five indicate the state of the phase voltage. Columns six to twelve indicate the switching state of the second switch elements. A one means that the switch is closed, a zero means that the switch is open.

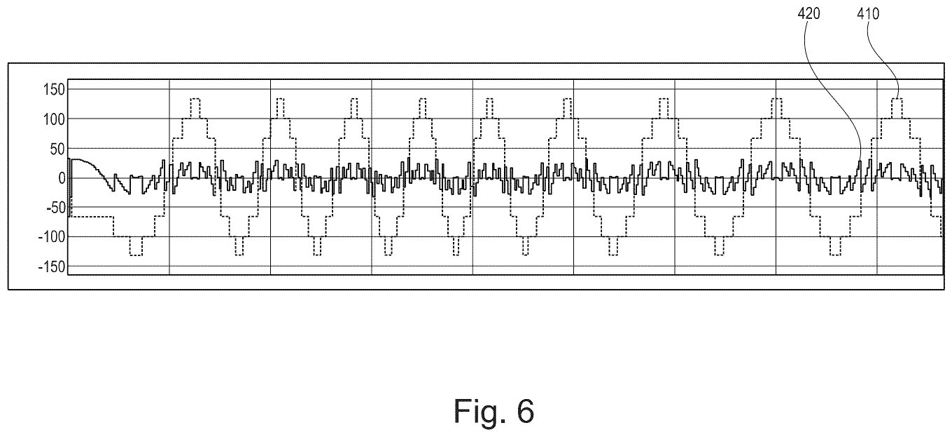

FIG. 6 shows the output voltage 410 of the DC/AC converter 40; 140; 240 for an electrical phase 62; 161 of the electric machine 60; 160; 260. The output voltage 410 has a twelve-pulse switching pattern. The twelve-pulse characteristic is due to the fact that additionally three possible voltage states can be set. These are plus, minus, and zero. Plus means that the phase is supplied with a positive voltage, minus with a negative voltage, and zero means that there is no voltage across the phase 62; 161 and therefore no current flows through the respective phase 62; 161. It turns out that when switching with a zero phase, the length of the voltage vector is shortened, such that one can only speak of a quasi-twelve-pulse three-phase voltage system. The zero state across a phase preferably occurs directly. Within the switching sequence, it can happen that the anti-parallel diodes 35; 133; 232 of the second switch elements 32; 135 clamp the phase voltage to plus or minus. The inductive behavior of the phases results in continued driving of the current despite switching on and off, and the corresponding diodes conduct. Once the current has dissipated, the diodes block and the actual voltage state is reached. Switching at the current zero crossing may at least partially prevent or shorten such unwanted clamping of the phase voltage.

Additionally, in the same diagram, FIG. 6 shows the adjusted voltage 420 at the output of the DC/DC converter 10; 110; 210 for an electrical phase 62; 161 of the electric machine 60; 160; 260. Superposition of the output voltage 410 of the DC/AC converter 40; 140; 240 with the adjusted voltage 420 at the output of the DC/DC converter 10; 110; 210 results in a quasi-sinusoidal curve of the phase current 430 of the electric machine 60; 160; 260.

The dynamically adjusted voltage 420 of the high-performance DC/DC converter 10; 110; 210 is within a limited amplitude range. The limited amplitude range of the adjusted voltage 420 is preferably in a range from zero to fifty percent, the adjusted voltage 420 in particular being intended to have an amplitude range of zero to one sixth of the intermediate circuit voltage.

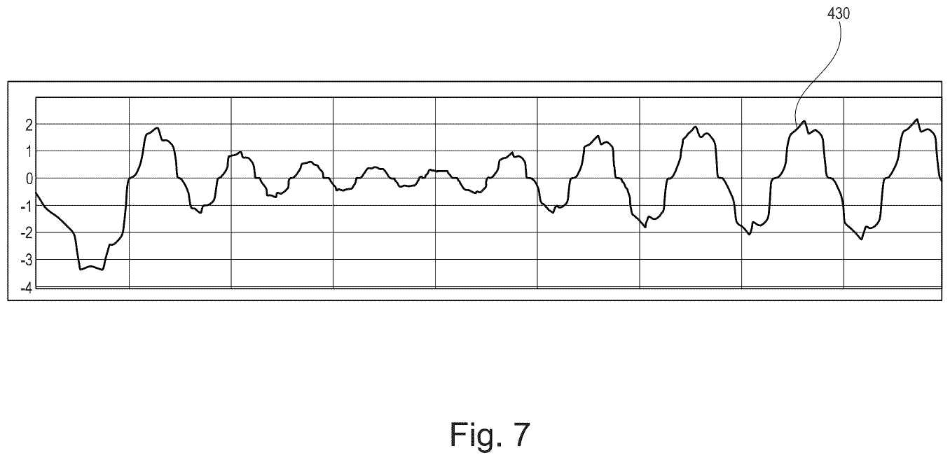

FIG. 7 depicts a quasi-sinusoidal shape of the phase current 430 in the electric machine. The quasi-sinusoidal shape of the phase current 430 in the electric machine results from the superposition of the output voltage 410 of the DC/AC converter and the adjusted voltage 420 of the DC/DC converter. The approximately sinusoidal shape of the phase voltage leads to an approximately sinusoidal shape of the phase current 430 in the electric machine.

### LIST OF REFERENCE NUMERALS

1. Electric converter device
2 Plus
3 Minus
10 DC/DC converter
11 DC input side
12 DC output side
13 AC/DC converter
14 DC/AC converter
15 Rotating current bridge circuit (primary)
16 Rotating current bridge circuit (secondary)
17 DC/DC resonant converter
18 Input terminals
20 High-frequency transformer
21 Capacitance
22 Inductance
23 Leakage inductance
24 Primary side
25 Secondary side
26 Three-phase transformer
27 Galvanic isolation
28 Planar transformer
29 Phase
30 Switch element
31 First switch element
32 Second switch element
33 Upper switch element
34 Lower switch element
35 Body diode
36 Half bridge
37 Switch
40 DC/AC converter
60 Electric machine
61 Wye connection
62 Electrical phase
63 Permanent magnet synchronous machine
81 DC current and voltage measurement
82 Intermediate circuit voltage measurement
83 Motor current measurement
84 Rotor position detection
90 Intermediate circuit
91 Intermediate circuit capacitor
100 Fuse
110 DC/DC converter
111 Full bridge on input side
112 Full bridge on output side
113 DC/DC resonant converter
120 Transformer
121 High-frequency transformer
122 Capacitance
123 Inductance
124 Leakage inductance
125 Supply line
126 Return line
130 Switch element
131 Half bridges
132 Switch
133 Diode
134 First switch elements
135 Second switch elements
140 DC/AC converter
141 Rotating current bridge circuit
160 Electric machine
161 Electric machine phase
190 Intermediate circuit
191 Intermediate circuit capacitor
200 Fuse
210 DC/DC converter
211 DC input side
220 DC/AC converter
221 Rotating current bridge circuit
222 Full bridge
230 Switch elements
231 Switch
232 Diode
240 DC/AC converter
241 Rotating current bridge circuit
250 Motor intermediate circuit
251 Intermediate circuit capacitor AC/DC
260 Electric machine
270 AC grid
280 Controller
290 Intermediate circuit grid
310 Drive control
315 Position control
316 Outer control loop
320 Speed control
321 Middle control loop
325 Current control
326 Inner control loop
330 Motor control
340 Cartesian-polar converter
350 Power electronics
360 MSK modulator
370 DC/DC converter control
380 CLLC modulator
390 Measurement data acquisition
401 Switching table
410 Output voltage DC/AC
420 Adjusted voltage
430 Phase current

1. A bidirectional n-phase electrical converter device having the following features:
input terminals for connecting a DC voltage source,
a DC/DC converter connected to the input terminals and comprising first switch elements,
p intermediate circuits connected to the DC/DC converter on the output side,
a DC/AC converter comprising second switch elements, the DC/AC converter being connected downstream of the p intermediate circuits,
the DC/AC converter comprising output terminals for connecting an electric machine or an electric AC grid,
a controller for controlling the second switch elements of the DC/AC converter such that a step-shaped n-phase output voltage can be provided, and
the DC/AC converter is designed as a fundamental-frequency-clocking rotor-controlled n-phase voltage system.

2. The electric converter device according to claim 1, wherein the electric converter device is designed as an n=3-phase device.

3. The electric converter device according to claim 1, wherein the controller controls the first switch elements such that the output voltage of the DC/DC converter is adjusted such that an at least approximately sinusoidal voltage signal can be provided at the n output terminals.

4. The electric converter device according to claim 3, wherein the output voltage of the DC/DC converter is adjusted within a limited amplitude range, wherein the limited amplitude range is between zero and fifty percent of an intermediate circuit voltage, and wherein the limited amplitude range is preferably between zero to one sixth of the intermediate circuit voltage.

5. The electric converter device of claim 4, wherein the second switch elements of the DC/AC converter are controlled according to an MSK method.

6. The electric converter device of claim 5, wherein the MSK control method comprises twelve switching states, and wherein the switching states are rotor position dependent.

7. The electric converter device of claim 6, wherein the control of the current and its torque depends on a rotor displacement angle Δε, and wherein one respective rotor displacement angle Δε is stored for different speed-to-torque combinations in one or more look-up tables.

8. The electric converter device of claim 7, wherein the electric machine comprises a mechanical commutation device.

9. The electric converter device of claim 8, wherein the p intermediate circuits are designed as capacitive intermediate circuits.

10. The electric converter device of claim 9, wherein the capacitive intermediate circuit comprises an intermediate circuit capacitor.

11. The electric converter device of claim 10, wherein a switching frequency of the first switch elements is in a range of about 500 kHz to about 1 MHz.

12. The electric converter device of claim 11, wherein the DC/DC converter comprises a three-phase high-frequency transformer.

13. The electric converter device of claim 12, wherein the high-frequency transformer is designed as a delta-wye-transformer, and wherein a primary side of the high-frequency transformer is connected in a delta connection and a secondary side of the high-frequency transformer is connected in a wye connection.

14. The electric converter device of claim 13, wherein the DC/DC converter is designed as a DC/DC resonant converter.

15. The electric converter device of claim 14, wherein the DC/DC converter is designed as a CLLC topology, wherein a CLLC topology includes two capacitances and two inductances of the high-frequency transformer.

16. The electric converter device of claim 15, wherein the arrangement of the impedances of the CLLC topology comprises first a capacitance, followed by two inductances, and a subsequent additional capacitance.

17. The electric converter device of claim 16, wherein the inductances of the CLLC topology are leakage inductances of the high-frequency transformer.

18. The electric converter device of claim 17, wherein the controller is configured to control the first switch elements and the second switch elements as a function of current, voltage, rotor position, and time.

19. The electric converter device of claim 18, wherein the DC/DC converter comprises a rotating current bridge circuit on an input side and on an output side.

20. The electric converter device of claim 19, wherein the rotating current bridge circuit comprises n half bridges, wherein each half bridge comprises two switch elements.

21. The electric converter device claims of claim 20, wherein the first switch elements are designed as silicon carbide (SIC) or gallium nitride (GaN) MOSFETs.

22. The electric converter device of claim 21, wherein the second switch elements are designed as IGBTs or MOSFETs.

23. The electric converter of claim 21, wherein the DC/DC converter and the DC/AC converter are arranged within a metallic housing.

24. A method for operating an electric converter device, the method comprising:
controlling at least one DC/DC converter via first switch elements and at least one DC/AC converter via second switch elements, wherein the second switch elements of the DC/AC converter are controlled such that the at least one output voltage of the DC/AC converter is pulse-shaped, and wherein the at least one output voltage of the DC/DC converter is adjusted between pulses of the output voltage of the DC/AC converter such that a quasi-sinusoidal phase current is formed at the output of the electric converter device.

25. The method of claim 24, wherein the second switch elements of the DC/AC converter are controlled according to the MSK method, and wherein the MSK method forms a twelve-pulse output voltage at the output of the electric converter device.

26. The method of claim 25, wherein the DC/DC converter is an actuator of an rotor-controlled n-phase voltage system, whereby an amplitude of the quasi-sinusoidal phase current is controlled by the DC/DC converter.

27. The method of claim 26, wherein the torque is controlled by the phase shift between the rotor-induced voltage and the rotor-controlled n-phase voltage system.

28. The electric converter device of claim 23, wherein the electric converter device is used for operating an electric machine or for supplying an electric n-phase AC grid.
